(19) United States
(12) Patent Application Publication
(10) Pub. No.: US 2014/0372215 A1
(43) Pub. Date: Dec. 18, 2014

(54) SYSTEM AND METHOD OF ADVERTISING USING RELATED SEARCH SITE LINKS

(71) Applicant: IAC Search & Media, Inc., Oakland, CA (US)

(72) Inventors: Douglas D. Leeds, Danville, CA (US); Jonathan M. Weinstock, Emeryville, CA (US); Katie P. Van Den Bos, San Francisco, CA (US)

(21) Appl. No.: 13/916,510

(22) Filed: Jun. 12, 2013

(51) Int. Cl. G06Q 30/02

(52) U.S. Cl. CPC G06Q 30/0256; G06Q 30/0275
USPC 705/14.54

(57) ABSTRACT

An advertiser computer system is described. A key phrase advertising index includes a plurality of key phrases. A relational data generator generates a set of related suggestions for each key phrase. An advertisement construction module stores an advertisement for each respective key phrase and inserts the related suggestions for the respective key phrase in the advertisement. A bidding engine is used for bidding on a key phrase on a search engine computer system. A user at a user computer system selects one of the related suggestions and a related suggestion execution engine receives the request signal from the user computer system.

### BACKGROUND OF THE INVENTION

1. Field of the Invention

This invention relates to a system and method of advertising using an advertiser computer system, a search engine computer system and a user computer system.

2. Discussion of Related Art

An advertiser computer system is often used to store key phrases and associated advertisements and then to bid for the key phrases at a search engine computer system. A user at a user computer system submits a query to the search engine computer system. The search engine computer system then provides results to the user computer system based on the query. If the bidding is successful and there is a match or a relationship between the query and a key phrase associated with the advertisement, then the search engine computer system also displays the advertisement to the user computer system.

In the past a search engine computer system would allow for the inclusion of an object such as text and an associated hyperlink within the advertisement. Recently, it has become possible for the inclusion of multiple objects, each with a respective hyperlink in one advertisement. An advertiser would typically include objects that, when selected by the user, would direct the user to different pages on an advertiser's web page. These links are commonly referred to as “site links.”

### SUMMARY OF THE INVENTION

The invention provides a method of advertising including storing, in an advertiser computer system, a plurality of key phrases, generating, with the advertiser computer system, a set of related suggestions based on and for each respective key phrase, storing, with the advertiser computer system, an advertisement for each respective key phrase, inserting, with the advertiser computer system, the related suggestions for the respective key phrase into the advertisement for the respective key phrase, bidding, with the advertiser computer system, for a key phrase on a search engine computer system corresponding to the key phrase on the advertiser computer system, uploading, with the advertiser computer system, the advertisement with the related suggestions onto the search engine computer system, the search engine computer system receiving a query and, if the bidding is successful and the query is related to the key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system, receiving, with the advertiser computer system, the request signal from the user computer system and causing, with the advertiser computer system, transmission of a response signal to the user computer system in response to the request signal.

The invention also provides an advertiser computer system that includes a processor, a computer-readable medium connected to the processor, a network interface device connected to the processor and a set of data stored on the computer-readable medium, including a key phrase advertising index that includes a plurality of key phrases, a relational data generator executable by the processor to generate a set of related suggestions based on and for each respective key phrase, an advertisement and keyword store, an advertisement construction module storing an advertisement for each respective key phrase and inserting the related suggestions for the respective key phrase in the advertisement and keyword store, a bidding engine bidding for a key phrase on a search engine computer system corresponding to the key phrase on the advertiser computer system and uploading the advertisement with the related suggestions onto the search engine computer system, the search engine computer system receiving a query and, if the bidding is successful and the query is related to a key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system, and a related suggestion execution engine receiving the request signal from the user computer system and causing transmission of a response signal to the user computer system in response to the request signal.

The invention further provides a non-transitory computer-readable medium having stored thereon a set of instructions which, when executed by a processor of a computer performs a method of advertising including storing, in an advertiser computer system, a plurality of key phrases, generating, with the advertiser computer system, a set of related suggestions based on and for each respective key phrase, storing, with the advertiser computer system, an advertisement for each respective key phrase, inserting, with the advertiser computer system, the related suggestions for the respective key phrase into the advertisement for the respective key phrase, bidding, with the advertiser computer system, for a key phrase on a search engine computer system corresponding to the key phrase on the advertiser computer system, uploading, with the advertiser computer system, the advertisement with the related suggestions onto the search engine computer system, the search engine computer system receiving a query and, if the bidding is successful and the query is related to the key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system, receiving, with the advertiser computer system, the request signal from the user computer system and causing, with the advertiser computer system, transmission of a response signal to the user computer system in response to the request signal.

### BRIEF DESCRIPTION OF THE DRAWINGS

The invention is further described by way of example with reference to the accompanying drawings, wherein:

FIG. 1 is a block diagram of an advertising system using related search site links;

FIG. 2 is a data structure of advertisement data before related suggestions are included;

FIG. 3 is a block diagram of a relational data generator forming part of an advertiser computer system in FIG. 1;

FIG. 4 is a data structure similar to FIG. 2 after related suggestions and hyperlinks have been added;

FIG. 5 is an advertisement that includes related search site links; and

FIG. 6 is a block diagram of a machine in the form of a computer system.

### DETAILED DESCRIPTION OF THE INVENTION

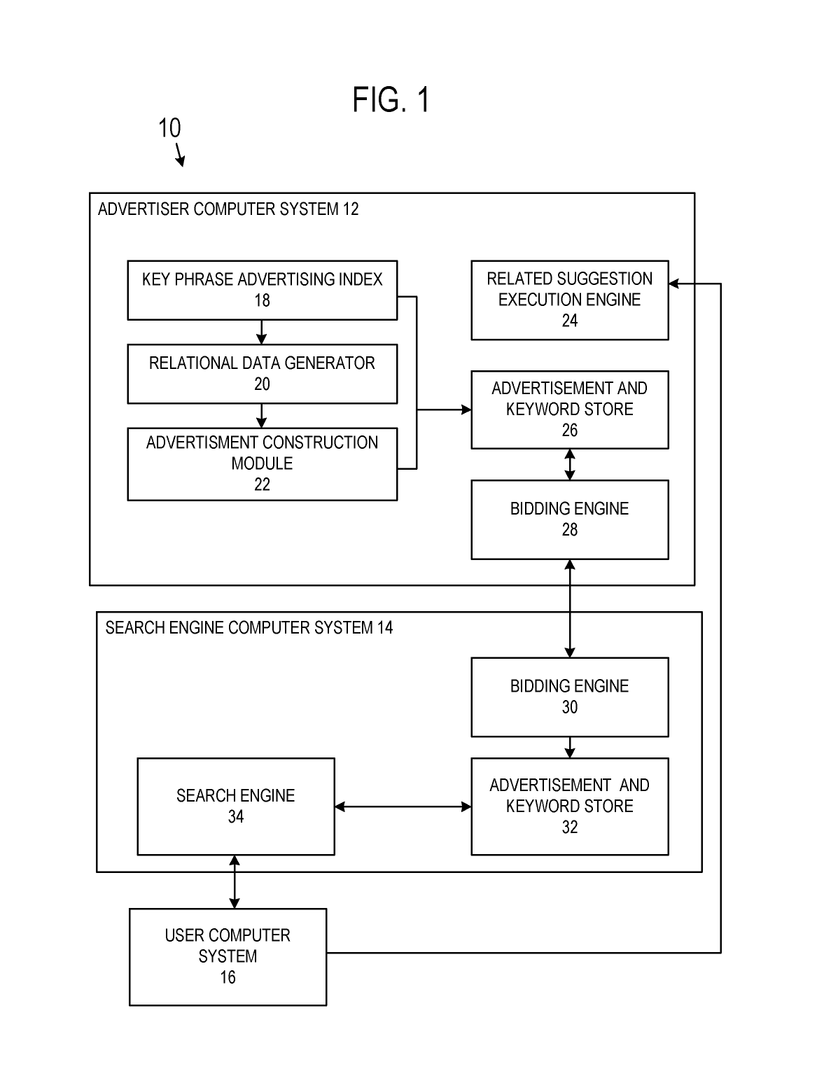

FIG. 1 of the accompanying drawings illustrates a system 10 that is used for advertising, including an advertiser computer system 12, a search engine computer system 14 and a user computer system 16.

The advertiser computer system 12 includes a key phrase advertising index 18, a relational data generator 20, an advertisement construction module 22, a related suggestion execution engine 24, an advertisement and keyword store 26, and a bidding engine 28. The key phrase advertising index 18 includes a list of key phrase that are used for bidding on by the advertiser computer system 12 at the search engine computer system 14. The relational data generator 20 is connected to the key phrase advertising index 18. The relational data generator 20 generates a set of related suggestions based on and for each of the respective key phrases in the key phrase advertising index 18.

The advertisement and keyword store 26 includes an advertisement for each respective key phrase in the key phrase advertising index 18. The advertisement construction module 22 is connected to the relational data generator 20 to receive the related suggestions from the relational data generator 20. The advertisement construction module 22 inserts the related suggestions for the respective key phrase into the advertisement for the respective key phrase at the advertisement and keyword store 26.

The bidding engine 28 is connected to the advertisement and keyword store 26. The bidding engine 28 is used for bidding for a key phrase on the search engine computer system 14 corresponding to each key phrase in the advertisement and keyword store 26 of the advertiser computer system 12. The bidding engine 28 is also used for uploading the advertisement with the related suggestions onto the search engine computer system 14.

The search engine computer system 14 includes a bidding engine 30, an advertisement and keyword store 32 and a search engine 34. The bidding engine 30 is connected to the bidding engine 28 of the advertiser computer system 12. The bidding engine 30 is also connected to a number of other advertiser computer systems owned by different entities. The bidding engine 30 determines whether a bid for a keyword is successful. The bidding engine 28 is used for entering an amount for the bid. If the amount is the highest for a key phrase, then the bidding engine 30 determines that the advertiser computer system 12 is successful and will enter the advertisement related to the key phrase on a results page to a user of the user computer system 16. The bidding engine 30 also stores the advertisement in the advertisement and keyword store 32 together with the related suggestions.

The search engine 34 of the search engine computer system 14 receives a query from the user computer system 16. If the bidding is successful for the advertiser computer system 12 within the bidding engine 30 and the query matches or is relevant to the key phrase that the bidding was for, then the search engine 34 transmits the advertisement with the related suggestions to the user computer system 16. The advertisement together with the related suggestions are then displayed within a browser of the user computer system 16.

A user at the user computer system 16 selects one of the related suggestions. Each one of the related suggestions has a respective hyperlink that sends a request signal from the user computer system 16 to the advertiser computer system 12. The related suggestion execution engine 24 of the advertiser computer system 12 receives the request signal based on the selection made by the user for the related suggestion. The related suggestion execution engine 24 then causes the transmission of a response signal to the user computer system 16 in response to the request signal received by the related suggestion execution engine 24 from the user computer system 16.

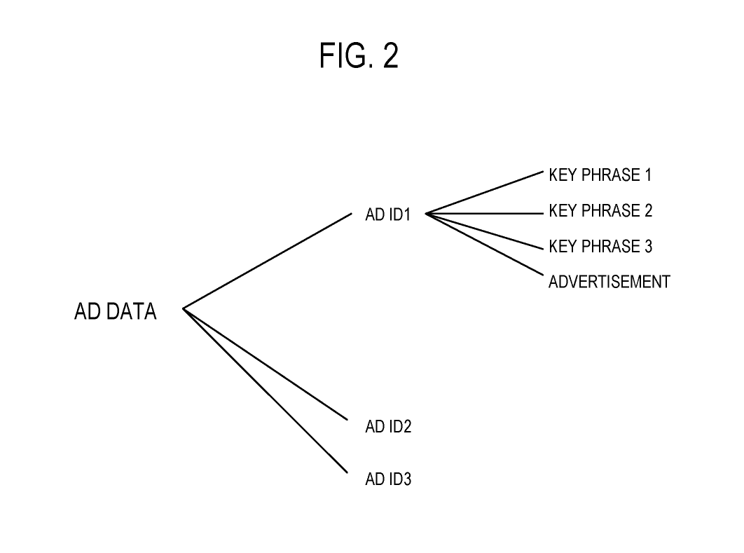

FIG. 2 illustrates advertisement data (Ad Data) that exists within the advertisement and keyword store 26 before the relational data is inserted. The advertisement data includes a number of advertisement IDs (Ad ID1, Ad ID2 . . . ). Each advertisement ID has a plurality of key phrases (key phrase 1, key phrase 2 . . . ) and an advertisement associated therewith. Each advertisement belonging to one advertisement ID can thus have a plurality of key phrases associated therewith. Different key phrases can then be used for bidding and placement of one advertisement.

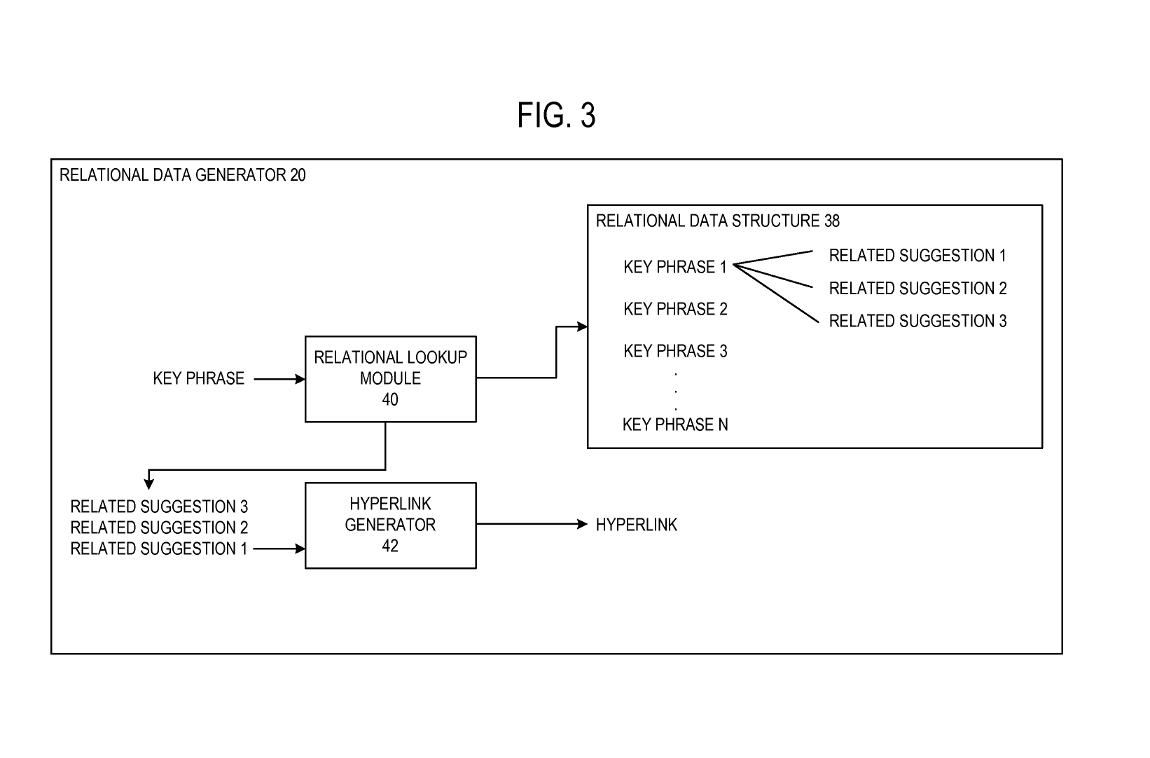

FIG. 3 illustrates the relational data generator 20 and its functioning in more detail. The relational data generator 20 includes a relational data structure 38, a relational lookup module 40 and a hyperlink generator 42. The relational data structure 38 includes a plurality of key phrases (key phrase 1, key phrase 2 . . . ) and a plurality of related suggestions (related suggestion 1, related suggestion 2 . . . ). Each key phrase (e.g. key phrase 1) has a plurality of related suggestions (related suggestion 1, related suggestion 2 . . . ) associated therewith.

The relational lookup module 40 receives each one of the key phrases in the advertisement data of FIG. 2 and uses each one of the key phrases to lookup a corresponding key phrase in the related data structure 38. Once the corresponding key phrase in the related data structure 38 is determined, the relational lookup module 40 extracts the related suggestions for the respective key phrase. The respective key phrase and the respective related suggestions (related suggestion 1, related suggestion 2 . . . ) are shown on the left-hand side in FIG. 3.

Each one of the related suggestions provided by the relational lookup module 40 is then entered into the hyperlink generator 42. The hyperlink generator 42 then generates a unique hyperlink corresponding to each one of the related suggestions. The hyperlinks are typically in the form of uniform resource locators (URLs).

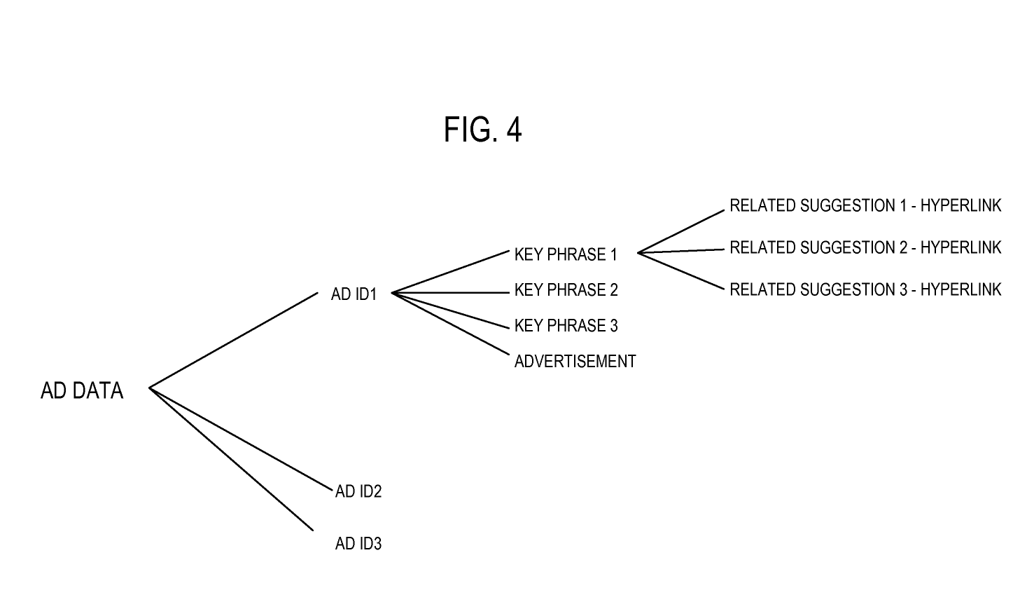

FIG. 4 illustrates the advertisement data in FIG. 2 after the advertisement construction module 22 has entered the related suggestions and hyperlinks received from the relational data generator 20. Each key phrase (e.g. key phrase 1) now has a plurality of related suggestions (related suggestion 1, related suggestion 2 . . . ) associated therewith. Each related suggestion (related suggestion 1, related suggestion 2 . . . ) has a respective unique hyperlink associated therewith.

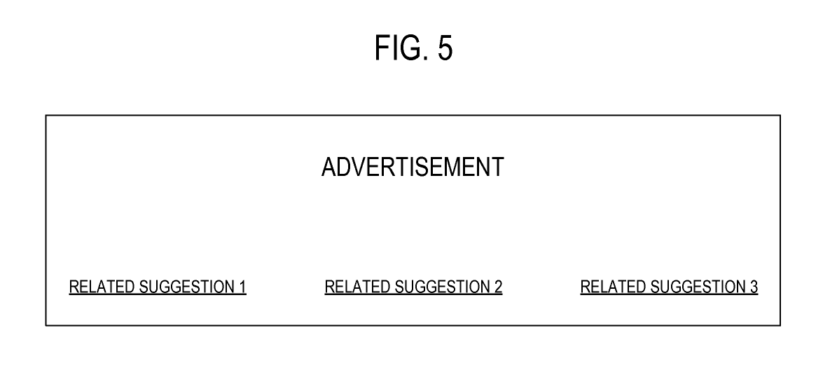

FIG. 5 illustrates an advertisement that is stored in the advertisement and keyword store 26 and ultimately displayed at the user computer system 16. The advertisement may have text or pictures therein. In addition, the advertisement has text for the related suggestions. When a user selects one of the related suggestions the respective unique hyperlink corresponding to the related suggestion causes transmission of a request signal to the advertiser computer system 12.

The related suggestion execution engine 24 may then redirect the user computer system 16 to a further computer system not shown in FIG. 1. Alternatively, the related suggestion execution engine 24 may execute an action based on the respective related suggestion selected by the user. For example, the related suggestion execution engine 24 may do an internal database search based on the related suggestion, transmit the related suggestion to a search engine and receive results based on the related suggestion, or generate further related suggestions based on the related suggestion.

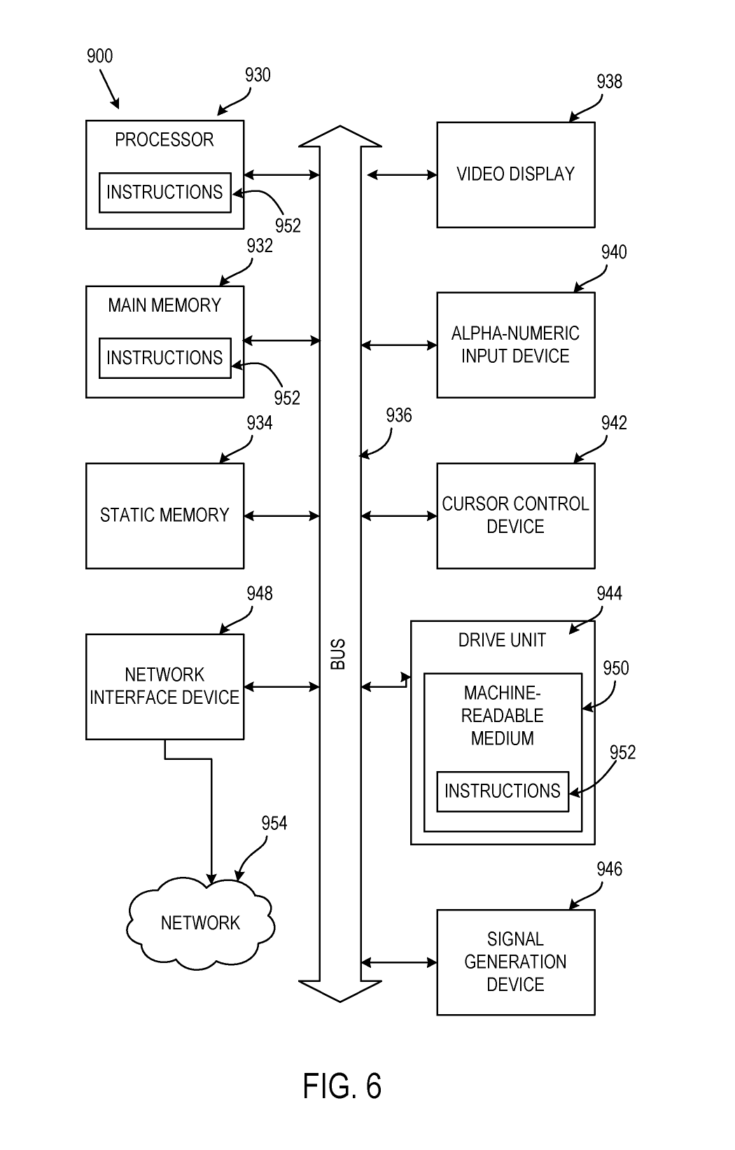

FIG. 6 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal display (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While the instructions 952 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of advertising comprising:
storing, in an advertiser computer system, a plurality of key phrases;
generating, with the advertiser computer system, a set of related suggestions based on and for each respective key phrase;
storing, with the advertiser computer system, an advertisement for each respective key phrase;
inserting, with the advertiser computer system, the related suggestions for the respective key phrase into the advertisement for the respective key phrase;
bidding, with the advertiser computer system, for a key phrase on a search engine computer system corresponding to the key phrase on the advertiser computer system;
uploading, with the advertiser computer system, the advertisement with the related suggestions onto the search engine computer system, the search engine computer system receiving a query and, if the bidding is successful and the query is related to the key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system;
receiving, with the advertiser computer system, the request signal from the user computer system; and
causing, with the advertiser computer system, transmission of a response signal to the user computer system in response to the request signal.

2. The method of claim 1, further comprising:
storing, with the advertiser computer system, the key phrases in a key phrase advertising index; and
storing, with the advertiser computer system, a relational data structure with key phrases and relational suggestions related to the key phrases, wherein the related suggestions that are generated are extracted from the relational database based on a matching of each key phrase in the advertising index to a respective key phrase in the relational database.

3. The method of claim 1, wherein transmission of the response signal to the user computer system includes redirecting the user computer system to a web page of another computer system other than the advertiser computer system or the search engine computer system.

4. The method of claim 1, wherein the transmission of the response signal to the user computer system includes transmission of search results to the user computer system based on the respective related suggestion.

5. An advertiser computer system that includes:
a processor;
a computer-readable medium connected to the processor;
a network interface device connected to the processor; and
a set of data stored on the computer-readable medium, including:
a key phrase advertising index that includes a plurality of key phrases;
a relational data generator executable by the processor to generate a set of related suggestions based on and for each respective key phrase;
an advertisement and keyword store;
an advertisement construction module storing an advertisement for each respective key phrase and inserting the related suggestions for the respective key phrase in the advertisement and keyword store;
a bidding engine bidding for a key phrase on a search engine computer system corresponding to the key phrase on the advertiser computer system and uploading the advertisement with the related suggestions onto the search engine computer system, the search engine computer system receiving a query and, if the bidding is successful and the query is related to a key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system; and
a related suggestion execution engine receiving the request signal from the user computer system and causing transmission of a response signal to the user computer system in response to the request signal.

6. The system of claim 5, further comprising:
a relational data structure with key phrases and relational suggestions related to the key phrases, wherein the related suggestions that are generated are extracted from the relational database based on a matching of each key phrase in the advertising index to a respective key phrase in the relational database.

7. The system of claim 5, wherein the response signal to the user computer system includes redirecting the user computer system to a web page of another computer system other than the advertiser computer system or the search engine computer system.

8. The system of claim 5, wherein the transmission of the response signal to the user computer system includes transmission of search results to the user computer system based on the respective related suggestion.

9. A non-transitory computer-readable medium having stored thereon a set of instructions which, when executed by a processor of a computer performs a method of advertising comprising:
storing, in an advertiser computer system, a plurality of key phrases;
generating, with the advertiser computer system, a set of related suggestions based on and for each respective key phrase;
storing, with the advertiser computer system, an advertisement for each respective key phrase;
inserting, with the advertiser computer system, the related suggestions for the respective key phrase into the advertisement for the respective key phrase;
bidding, with the advertiser computer system, for a key phrase on a search engine computer system corresponding to the key phrase on the advertiser computer system;
uploading, with the advertiser computer system, the advertisement with the related suggestions onto the search engine computer system, the search engine computer system receiving a query and, if the bidding is successful and the query is related to the key phrase that the bidding was for, transmitting the advertisement with the related suggestions to a user computer system, a user at the user computer system selecting one of the related suggestions, each related suggestion having a respective hyperlink that sends a request signal from the user computer system to the advertiser computer system;
receiving, with the advertiser computer system, the request signal from the user computer system; and
causing, with the advertiser computer system, transmission of a response signal to the user computer system in response to the request signal.
